(19) United States
(12) Patent Application Publication
(10) Pub. No.: US 2007/0244737 A1
(43) Pub. Date: Oct. 18, 2007

(54) AUTOMATIC GOLF PLAYER MATCHING AND SCHEDULING SYSTEM

(76) Inventor: Melvin Herrin, Sarasota, FL (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/733,806

(22) Filed: Apr. 11, 2007

Related U.S. Application Data
(60) Provisional application No. 60/792,138, filed on Apr. 13, 2006.

(51) Int. Cl. G06F 9/46

(52) U.S. Cl. 705/9

(57) ABSTRACT

An automatic invitation and scheduling system for organizing foursome for golf games. A players fills out a questionnaire related to golf game preferences. The questionnaire is loaded into a database. When a game is desired a player indicates the desire to play a game and invitations are sent out based upon the criteria. A tee time is automatically scheduled and confirmed based upon the responses. This assists in eliminating the very time consuming and sometimes unsuccessful exercise of arranging golf games.

This application claims the benefit of U.S. Provisional Application No. 60/792,138 filed on Apr. 13, 2006, the entirety of which is hereby incorporated by reference.

### BACKGROUND OF THE INVENTION

1. Field of Invention

The invention relates to the field of golf. In particular, the invention relates to an automated system and method for planning and establishing groups for a round of golf.

2. Description of the Related Technology

When a sports player moves to a new area or joins a club he or she frequently is unfamiliar with the people who are already members. In a game such as golf, playing with a group, such as a foursome, can be important and enhances the overall satisfaction of the game. Even for those who are familiar with the other members of a club it is sometimes difficult to consistently find people who are willing to play at the same time. Arranging groups of multiple players who are at the same level of play can also prove to be a challenge as well as very time consuming.

In the past there have been attempts made in the field of golf to address the problem of finding suitable players. There have been databases established that a person may use in order to search for compatible players, however these databases do not help in the scheduling a tee time. Furthermore, these databases do not reach out to players who may or may not be interested at any given time in a game.

Therefore, there remains a need to provide an automatic method and system for player matching and scheduling of games for groups of players.

### SUMMARY OF THE INVENTION

A first aspect of the invention can be a method for forming groups of compatible players for playing games is disclosed. The method can have the step of providing a plurality of questionnaires to a plurality of players. The method can also have the step of compiling the plurality of questionnaires from the plurality of players in order to obtain data related to the plurality of players. Another step in the method can be receiving a request to play a game from one of the plurality of players. The method can also the steps of analyzing the data and selecting from the plurality of players a number of players based upon the request and the data of the requesting player. The method can also include transmitting invitations to the number of players and receiving responses from at least a portion of the number of players. A group may then be formed based upon these responses. A time of play can then be scheduled for the group.

A second aspect of the invention can be a system for establishing compatible groups of players. The system can have a database having data about a plurality of players. The system further may have a processor having a scheduling algorithm for analyzing the data, wherein the processor may have means for receiving a request to establish a play time, wherein the processor further has means for automatically transmitting results from analyzing the data and the request to select a group of players, the processor further adapted to automatically schedule a play time for said group of players.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWING(S)

FIG. 1 is a flow chart depicting the method of scheduling a game for a group of players.

FIG. 2 is a diagram depicting the system used for scheduling games for a group of players.

### DETAILED DESCRIPTION

The problem of finding suitable opponents or co-players with which to compete with is a problem that affects every game player. This problem is especially evident in a game such as golf. The length of the game as well as the problems associated with coordinating up to four compatible people to play the game is something that affects all players. Furthermore, this is additionally problematic for a player who wants to play at a new course or in a new club and who is not familiar with the other players. By providing effective automatic matching and scheduling a player does not have to worry about being able to find suitable opponents and/or co-players, nor does he or she have to be concerned with the difficulties of actually coordinating or scheduling the event.

The instant invention provides a method and system that provides automatic matching and scheduling of games for players. The method and system gives a community or club the ability to pair new or existing members up with other “compatible” players based on a number of criteria. For example, handicap, match preference, availability, tee preference, etc. can be used as criteria. This system not only benefits new and existing members, but also gives the golf clubs and developers using the system a powerful marketing tool. One of the main reasons a person chooses not to join a club or buy in a golf community is because they feel it may be difficult to find a game. Furthermore, some people are only in an area during certain times of the year, which also creates problems in finding suitable players for a game. The system and method provides a player with the most suitable players available at any given time so as to ensure a pleasurable game experience.

Administration of the system is efficient, inexpensive and easy. This system allows members to communicate once and have their tee time and game arranged and confirmed for them. This avoids the problem of usually having to make multiple phone calls or transmission of e-mails in order to establish a suitable time and game. A player is able to enter their specific criteria and have a game automatically scheduled and confirmed for them. These players can then meet at the location of the game and play.

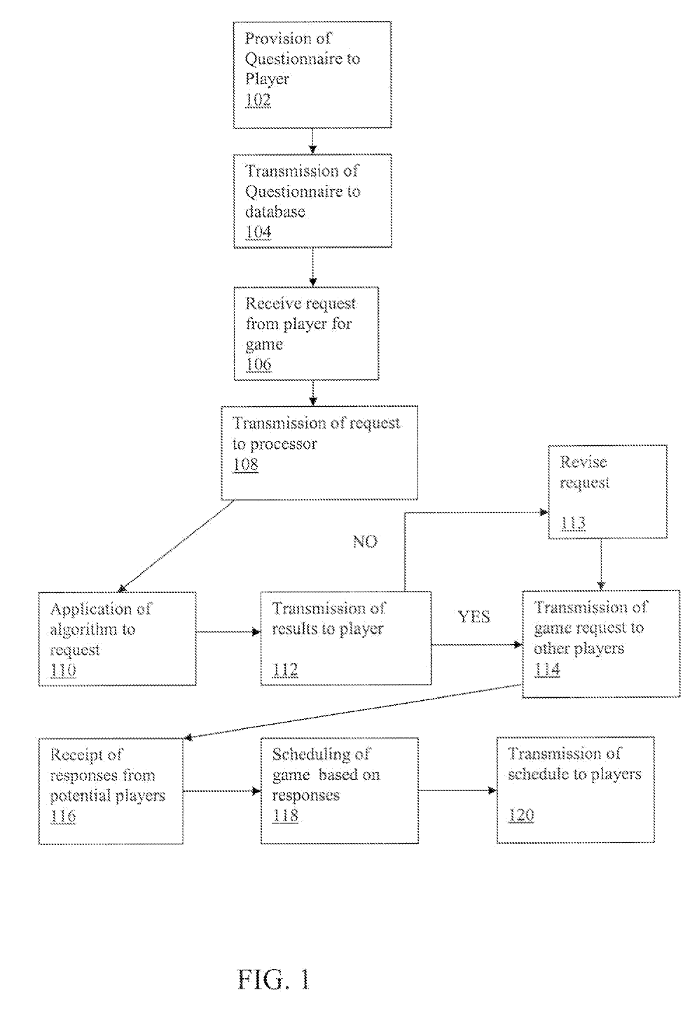

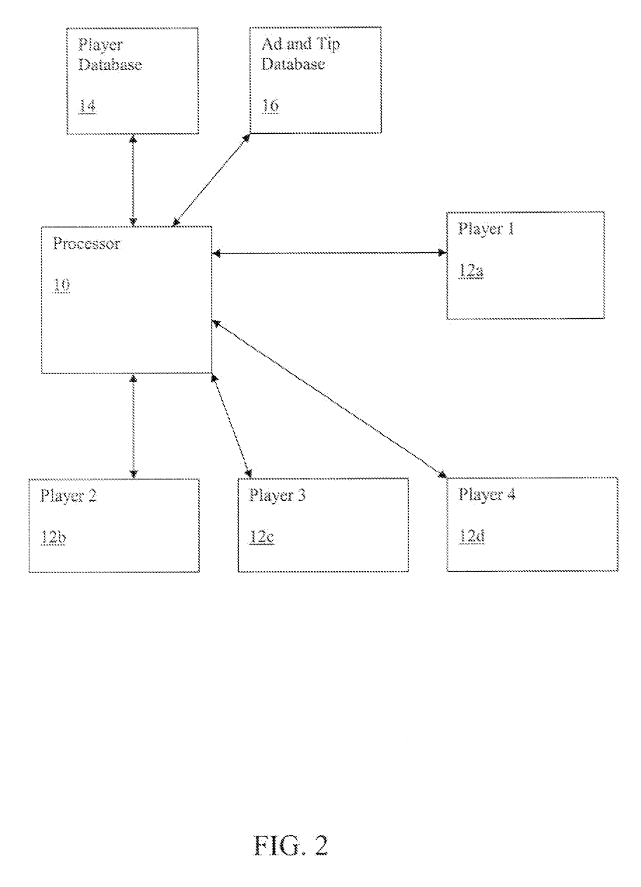

FIG. 1 shows a flow chart that illustrates a preferred embodiment of the method of the invention. FIG. 2 illustrates a diagram of a preferred embodiment of the system used in the method. Using the method, at step 102 a questionnaire is provided to a player when he/or she joins the club or community. It should be understood that existing members of the respective club or community may also complete questionnaires as well. A player 12a fills out the questionnaire or alternatively has an interview that covers the specific criteria used for matching in the system. The questionnaire may be provided online, via paper, or may be conducted via a telephone. After the questionnaire is filled out, at step 104 the data is transmitted to a database 14, which may be managed by a processor 10, which is part of the computer system that maintains the automatic scheduling system. It should be understood that the processor 10 may be one of many processors used in the system and may be part of a LAN, or WAN that handles the scheduling tasks of the system. For purposes of explanation in the application, the system is generally referred to as the processor 10. In a simplified version of the system, the processor 10 may be acting as server in order to provide information to the players 12a-12d, or to the service that provides the information to the players. The transmission of data to the database 14 can be done online or by having service personnel enter the information after receiving answers to the questionnaire from the player 12a. Table 1 shows an example of a questionnaire that can be used for golf games.

TABLE 1
Sample questionnaire:

First Name:
Last Name:
Date of Birth: / /

| | | |
|---|---|---|
| Sex: M \| F | Handicap: USGA | Club: |
| Contact | Phone: ( ) - | Email: |
| information: | | |
| Fax: | | |

| | |
|---|---|
| Day preferences: | Mon Tue Wed Thu Fri Sat Sun |
| Time preferences: | |

Lunch breaks: Y/N
Tee preferences: Red Blue White
Walking preference: Walking/Riding/Take a Caddie
Playing preference: Male Female Couples Family
Wagering Preference: No Wager/Wager Type of Game
Handicap Range of Matches:

Additional criteria can be used for the questionnaires, such as average time per round, month and seasonal availability, and preferences regarding other game types. Additionally, preferred players may be added as well, which would preempt matching with other players in the event that the preferred player is available to play. The profiles that are built based upon the questionnaires may be periodically updated form time to time. They may be updated once a month, once a year, or after every round of golf. This can be accomplished manually or occur via an automatic updating system based upon scores and/or results provided by the player. For example, handicap information can be updated periodically, as well as any of the other criteria found within the profile. Furthermore, it may be possible for player 12a to rate and rank those other players with which he has played, thereby providing additional information that the program can use in order schedule groups in the future. Players may be identified throughout the system by their club membership number, or some other piece of identifying information. This can make for a more streamlined search process and requires no additional information for a player to memorize. Additionally, the scheduling system may be regional or expanded based upon those clubs or groups that wish to be part of the network.

Now returning to the process shown in FIG. 1, at step 106, the player 12a makes a request to play at a certain time. The time chosen can be used to search within a certain frame of times. Player 12a can communicate the request online, by phone, by email or by fax to system to which the processor 10 is located. Player 12a need only provide their identification number and the day and time that they want to play. The system can be further expanded so that the player 12a can add additional information regarding specific criteria for the game. These specific requests can act as temporary amendments to the profile of the player 12a for matching purposes. At step 108, the processor 10 performs the scheduling algorithm to match the player 12a with appropriate players. At step 110, the scheduling algorithm is applied to the specific request. The scheduling algorithm may use a variety of ways to select the ideal players.

One method can be accomplished by applying a weighting algorithm to various factors used in the questionnaire. This will provide a ranking for those players that are scheduled so that when the number of potential players exceeds a given request the rankings can be used to select the preferred players. Alternatively, instead of rankings, percentages of compatibility may be assigned to each of the players and subsequently used in order to pair players. It is also possible to for an individual to manually search the database for other compatible members and tee times in the system should he or she so desire.

Returning to FIG. 1, at step 112, the results are transmitted to the player 12a via which ever method the player 12a prefers. Results may be provided by e-mail, phone call, fax, etc. and/or a combination of these methods. At step 113, the player 12a may approve the results and send back a confirmation of approval, in which case the method moves on to step 114, if a player 12a does not approve of the tentative selection he or she may alter selection criteria or simply cancel the registration. Alternatively, steps 112 and 113 may be bypassed, and the player 12a may agree to play with whomever the scheduler selects.

Still referring to FIG. 1, at step 114, requests to play are transmitted to the players 12a-12d. It is possible to have requests to play transmitted to more than just players 12a-12d. Given the potential inability for some players to be unavailable, multiple requests may be transmitted. At step 116 the potential players respond as to whether or not they are capable of playing. If a potential player does not respond after a predetermined amount of time it will operate as a negative response. The predetermined window of time for potential responses may range from a few hours to a week or more depending on whether a default time is selected for response or a specific time frame is selected.

Once a sufficient number of positive responses are received, the scheduling of the game is performed by automatically reserving the tee times with the golf course. The system can utilize those positive response received first, or alternatively select the most ideal matches from those received. At step 120, the schedule and tee reservation is transmitted to the players 12a-12d. Additional players who responded affirmatively may also be scheduled to play during the same time frame. Not only does the transmission of invitations to players foster good gamesmanship it also prompts players who may not have intended to play at a certain time to now play. The receipt of an invitation can act as an impetus for a potential player to engage in a game that would have otherwise remained idle. This can be used to increase the number of players that otherwise would have refrained from playing due to lack of compatible players and for a game such as golf, this can be used to foster an increase in game fees, cart rentals, pro shop sales, etc.

Now turning to FIG. 2, an ad and tip database 16 is shown that is also used with the system. Database 16 may store ads that are geared for specific players based upon the criteria that was provided in the questionnaire. For instance, someone who has a very high handicap may be receptive to ads and/or tips geared to improve his or her overall golfing experience. The system through the operation of the processor 10 may employ an algorithm that enables selection of the appropriate ad and/or tip. For example, data relates to age, time of play and handicap can be used for selecting the appropriate ad (e.g. golf lessons, or corrective clubs for a player with a high handicap). These ads and tips may be attached to both requests and confirmations.

Although the invention as shown and illustrated is directed towards golf games it is possible to utilize the system for any game that requires more than one individual and for which criteria for selecting players can be developed, such as tennis, or chess.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method for forming groups of compatible players for playing games comprising:
providing a plurality of questionnaires to a plurality of players;
compiling said plurality of questionnaires from said plurality of players in order to obtain data related to said plurality of players;
receiving a request to play a game from one of said plurality of players;
analyzing said data;
selecting from said plurality of players a number of players based upon said request and the data of said one of said plurality of players;
transmitting invitations to said number of players;
receiving responses from at least a portion of said number of players;
forming a group based on said responses; and
automatically scheduling a time of play for said group.

2. The method of claim 1, wherein said initiations further comprise an advertisement directed towards one of said plurality of players.

3. The method of claim 1, wherein said game is golf.

4. The method of claim 3, further comprising the step of automatically establishing a tee time for said group.

5. The method of claim 1, wherein said data obtained comprises golf handicap, preferred game type, and cart preference.

6. The method of claim 1, wherein said number of players selected is weighted based upon said data.

7. The method of claim 1, wherein a confirmation is sent to said players.

8. The method of claim 1, wherein said responses are used to form a plurality of groups.

9. The method of claim 1, wherein said data obtained further comprises preferred players and responses include preferred players, seasonal availability and weekly availability.

10. The method of claim 1, wherein the number of players selected is greater than the number required to form a group for golf.

11. A system for establishing compatible groups of players comprising;
a database having data about a plurality of players;
a processor having a scheduling algorithm for analyzing said data, wherein said processor has means for receiving a request to establish a play time, wherein said processor further has means for automatically transmitting results form analyzing said data and said request to a select a group of players, said processor further adapted to automatically schedule a play time for said group of players.

12. The system of claim 11, further comprising a second database having information selected from the group consisting of advertisement and tips.

13. The system of claim 12, wherein said processor further has a matching algorithm for selecting said information from said second database based upon data about said select group of players.

14. The system of claim 11, wherein said play time for said group of players is at a golf course.

15. The system of claim 11, wherein a number of players is selected from the plurality of players that is greater than the players required for a game of golf.

16. The system of claim 11, wherein a tee time is automatically scheduled at a golf course for said group.

17. The system of claim 11, wherein said data obtained comprises golf handicap, preferred game type, and cart preference.

18. The system of claim 11, wherein said data obtained comprises preferred players, seasonal availability and weekly availability.

19. The system of claim 11, wherein a compatibility percentage is calculated for each of the plurality of players with respect to each other.
